(19) United States
(12) Patent Application Publication
(10) Pub. No.: US 2018/0012135 A1
(43) Pub. Date: Jan. 11, 2018

(54) QUERY-TARGET REFINEMENT IN A DISTRIBUTED MOBILE SYSTEM

(71) Applicant: INTERNATIONAL BUSINESS MACHINES CORPORATION, Armonk, NY (US)

(72) Inventors: Supriyo Chakraborty, White Plains, NY (US); Jorge J. Ortiz, Rego Park, NY (US); David A. Wood, III, Scarsdale, NY (US)

(21) Appl. No.: 15/202,747

(22) Filed: Jul. 6, 2016

(51) Int. Cl. G06N 7/00; G06F 17/30

(52) U.S. Cl. CPC G06N 7/005; G06F 17/30477

(57) ABSTRACT

A method for executing a query includes determining one or more nodes that are likely to have local content that matches a search query. The determination is based on a location profile for each of the one or more nodes and a conditional probabilistic model for each of a set of distinct locations. The search query is executed at the one or more nodes.

### BACKGROUND

### Technical Field

The present invention generally relates to search query refinement and execution and, more particularly, to using contextual information to refine query targets for fuzzy search queries.

### Description of the Related Art

The increasing prevalence of mobile devices and the increasing processing capabilities of such devices provides access to kinds of information that were not previously available. In a network of mobile devices, each with advanced sensing and processing capabilities, information can be acquired rapidly from the most appropriately positioned device.

However, existing approaches for collecting information through, e.g., search queries for specific applications are inadequate to fully take advantage of the power of such distributed networks. While crowdsourcing is one approach to organizing such distributed information, it necessitated active engagement by the users of the network and can put a high burden on the individual users.

### SUMMARY

A method for executing a query includes determining one or more nodes that are likely to have local content that matches a search query, using a processor. The determination is based on a location profile for each of the one or more nodes and a conditional probabilistic model for each of a set of distinct locations. The search query is executed at the one or more nodes.

A method for executing a query includes constructing a conditional probabilistic model of each of a plurality of locations for a server and for one or more nodes, with the conditional probabilistic model for the one or more nodes being further based on locally stored information. One or more nodes that are likely to have local content that matches a search query are determined. The determination is based on a location profile for each of the one or more nodes and includes calculating a probability that each of one or more nodes possesses content that matches the search query based on the conditional probabilistic model, each node's respective location profile, and location information from the search query. The search query is executed at the one or more nodes.

A system for executing a query includes a query refinement module that has a processor configured to determine one or more nodes that are likely to have local content that matches a search query. The determination is based on a location profile for each of the one or more nodes and a conditional probabilistic model for each of a set of distinct locations. The query refinement module forwards the search query to the one or more nodes for execution.

These and other features and advantages will become apparent from the following detailed description of illustrative embodiments thereof, which is to be read in connection with the accompanying drawings.

### BRIEF DESCRIPTION OF THE SEVERAL VIEWS OF THE DRAWINGS

The disclosure will provide details in the following description of preferred embodiments with reference to the following figures wherein:

FIG. 1 is a block diagram of a query execution system in accordance with the present principles;

FIG. 2 is a block/flow diagram of a method for executing a search query in accordance with the present principles;

FIG. 3 is a block diagram of a query processing system in accordance with the present principles;

FIG. 4 is a block diagram of a mobile node in accordance with the present principles;

FIG. 5 is a block diagram of a processing system in accordance with the present principles; and

FIG. 6 is a block/flow diagram of a method of constructing conditional probabilistic models in accordance with the present principles.

### DETAILED DESCRIPTION

Embodiments of the present invention provide fuzzy search query refinement and execution in a distributed system of mobile devices. The present embodiments uses information regarding what the query is searching for, the locations of the mobile devices, the time, and other contextual factors to find query results with minimal involvement from the users of the mobile devices and from the user who issued the query.

In one exemplary embodiment, the prior search history and the user location profiles are used to construct a spatio-temporal summary of the objects and people in a location. The present embodiments then refine the query automatically and return responses with the highest probability of success. In this example, a first user may be seeking images of an event that is taking place at a certain location in a city. Many people in that city may have mobile devices with them, and some may be close to the event and have pictures of it. The first user issues a fuzzy query—for example, phrased in natural language—describing what they are looking for. The present embodiments examine the pictures on the mobile devices and determine the likelihood of whether the content being requested is present or is likely to be obtained in each device's images. The present embodiments use information from multiple sources to calculate a conditional probability that the query can be positively satisfied, for example including the device's location, movement trajectory, data or image content, time, etc. Those devices with the highest likelihood send their data back to the first user.

By improving query refinement, the burden on the user is decreased as the number of search attempts needed to manually refine the search is decreased. In addition, the network traffic imposed by the system is decreased, as multiple levels of the system make a determination as to whether to transmit data, thereby reducing the network burden caused by retrieving false-positive results to a query.

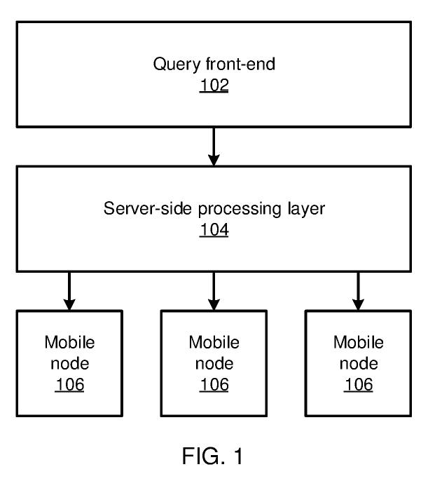

Referring now to FIG. 1, a distributed query system is shown. A query front-end 102 receives a search query from a user. The search query may be a “fuzzy” query, such as a natural language query, or may alternatively be a structured query. The query may include a set of subjects and predicates that have information about what, where, whom, and when to obtain results (which may, it should be noted, be specified to run forever to form a continuous query). This information may be extracted from the query using natural language processing or may be explicitly specified in, e.g., a database-style interface. The query may, for example, specify a particular piece or type of digital content that may be expected on a mobile device. The present embodiments are discussed with respect to searching for an image or other multimedia content, but it should be understood that the present principles may extend to any form of digital content.

The query front-end 102 parses the incoming query into its constituent pieces and passes the extracted information to a server-side processing layer 104. The query front-end 102 may be a software application that runs locally on a user's mobile device, laptop, or desktop computer. Alternatively, the query front-end 102 may be a web application or any other form of server-based software that the user interacts with remotely.

The server-side processing layer 104 keeps track of each node 106 in the network and is able to communicate with the nodes 106 if needed. When a query is submitted at query front-end 102, the server-side processing layer 104 uses location profiles to filter the nodes 106 to which the query will be sent. Nodes 106 that are in locations most likely to have the searched-for object will receive the query.

When the server-side processing layer 104 receives a response to a query, it uses the received information to construct a probabilistic model of the relationship between the query and the responses. For example, if query asks for pictures of the Empire State Building, the server-side processing layer 104 constructs a model that relates the term, “Empire State Building,” to the received responses. Each response should also include contextual information such as the location, present time, and identity of the responder, which allows the server-side processing layer 104 to construct the model.

After the server-side processing layer 104 issues the query to the filtered list of mobile nodes 106, each mobile node 106 that receives the query runs a local process that communicates with the server to obtain any additional information that may be needed and makes a determination as to whether its local content matches the query. In particular, the mobile node 106 scans its local content to determine whether the object of the search query is present. The local content could include, for example, images or other sensor readings.

In addition, each mobile node 106 keeps models of its data set that allows the mobile node 106 to probabilistically determine whether it has the sought-after information. Such models can be kept locally at the mobile node 106 or can be shared with the server-side processing layer 104. There is a tradeoff between performance and the potential risk to privacy from information sharing. Filtering of the shared information to reduce the risk to privacy can take place on either the mobile node 106 or at the server-side processing layer 104.

Both the server-side processing layer 104 and the individual mobile nodes 106 construct probabilistic models. The server-side models are constructed using prior history and responses to queries from the nodes 106 and relate the content of the query response with the subjects and predicates of the query. There are many ways to construct such models. For example, a classifier may be built based on the predicates of a query and the characteristics of successful responses to the query. One instantiation of such a classifier could parse the input query, treating the predicates as a collection of strings. The strings could either be mapped directly to characteristic features of the results or to a topic.

For topic modeling, N-gram feature extraction coupled with a Random Forest classifier could be used. Alternatively, textual topic analysis, such as Latent Dirichlet Allocation may be used. A similar classification may be performed for the results. For example, if the results are images with tags or captions, then the caption information can be combined with a neural network to summarize the images as text. That text can be combined with the topic model pipeline to characterize the query predicate. The match between the query topics and the image is then scored and, if a high enough score is found, the image may be returned as a query result.

Location profiles, which are stored at the server-side processing layer 104 and which characterize mobile node locations, can be maintained using a lower order Markov chain. The places visited by a user are the nodes of the Markov chain, with the edges between the nodes representing transition probabilities or the frequency of visit to places over time. Such a location model is both succinct and predictive, making it a good indicator of a user's travel patterns.

The models may also be made sensitive to timing. For example, query responses may be different at different times, both depending on when the query was issued and when the query was answered. Timing information can be actively used to update the conditional probability distributed in relation to the components of the query.

In addition to server-side models, the individual mobile nodes 106 construct models using node-specific data, such as local images, audio, video, location, and other sensor data. This information is used to characterize the local data. Time can also be used along with location history and sensor information to calculate and predict future movement patterns. Neural networks may be used in particular to form classifiers on the mobile nodes 106. Such neural networks may be pre-trained with parameters being distributed to the mobile nodes 106.

Classifiers and probabilistic models may be implemented at both the server-side processing layer 104 and at the individual nodes 106 to take advantage of the different kinds of information available at each. In particular, the individual nodes 106 have access to local data that is not present at the server. The server-side processing layer 104, meanwhile, has access to feedback from many nodes 106 and can provide general topic matching.

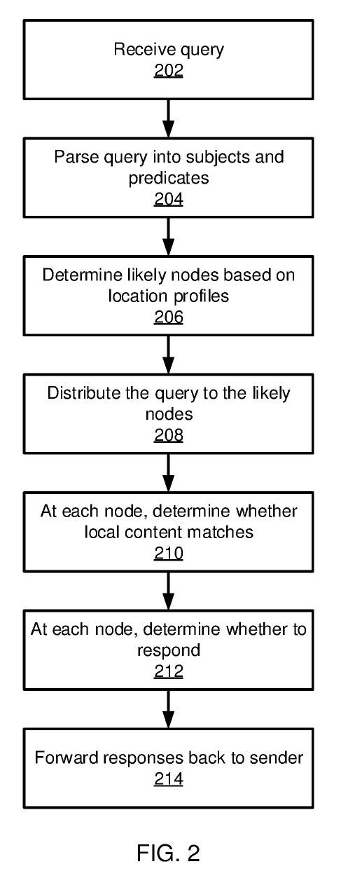

Referring now to FIG. 2, a method for performing a search is shown. Block 202 receives the search query from a user through the query front-end 102. As noted above, the query itself may be a fuzzy query or may be structured. Block 204 analyzes the query to extract relevant information, including contextual information pertaining to the query.

Block 206 uses location profiles for the nodes 106 to determine which nodes are likely to have information pertaining to the query. This may be based on, for example, a location profile that indicates that a given node 106 was recently in an area of interest for the query or, alternatively, that the node 106 will soon be at such an area of interest. The server uses information about the location of a mobile node 106 (e.g., its longitude and latitude coordinates) to associate with that location a geographic region, which can further be combined with information about the location from web resources.

The server-side processing layer 104 uses this information to build a topic model, for example, using latent Dirichlet allocation based on both textual and visual features as constituents of a latent topic mixture. The hyper-parameters of the latent model can be learned or determined through experimentation, as the model is defined by two parameters that are set a priori. Using this information, block 206 determines the most likely mobile nodes 206 and block 208 then distributes the query to those nodes.

At each node 106, block 210 determines whether the local content matches the query. This may include image analysis to determine, for example, whether the requested content is visible in any stored images. The analysis of block 210 may additionally include any textual or contextual information attached to the content, for example if the user tags or captions the image with text that indicates a match. This determination can be made based on a general local model, similar to the sever-side model, that runs on each mobile node 106. Once each model is trained, the posterior distribution will be affected by the data that is fed into each model. The results of the model (e.g., the topic or topic mixture distribution) will be matched with the keywords provided in the search query. To accomplish this, the system transforms the keywords of the search query into a vector and the model is used to determine the probability that the generative topic model would generate the search vector if sampled from the posterior. If the likelihood is below a certain threshold, the mobile node 106 determines that it is not likely to have relevant information and does not answer the query.

Even if a match is found, however, block 212 determines whether the node 106 will respond. In particular, this determination can be based on the device's battery level, the computational resources available, and the type of information being sought in the query. Assuming there is a match in the local content and assuming the node is able to respond, block 214 forwards the responses back to the server-side processing layer 104 which, in turn, presents the results to the originating user.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

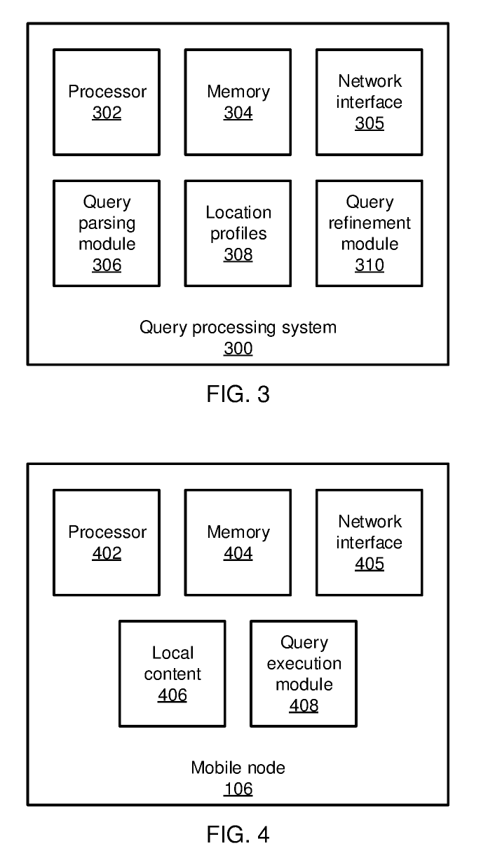

Referring now to FIG. 3, a query processing system 300 is shown. In one embodiment the query processing system 300 includes the server-side processing layer 104, while in another embodiment the query processing system also includes the query front-end 102. The query processing system 300 includes a hardware processor 302 and a memory 304. A network interface 305 allows the system 300 to receive query information from a searching user and to communicate with the mobile nodes 106. In addition, the system 300 includes one or more functional modules. In one embodiment, the functional modules may be implemented as software that is stored in memory 304 and is executed by hardware processor 302. In an alternative embodiment, the functional modules may be implemented as one or more discrete hardware components, for example in the form of application specific integrated chips or field programmable gate arrays.

A query parsing module 306 analyzes a received query and extracts query terms from it. Based on stored location profiles 308 for the respective mobile nodes 106, as well as any other contextual information that may be available, a query refinement module 310 determines which mobile nodes 106 are likely to have information pertinent to the query. In particular, the query refinement module 310 uses one or more probabilistic models or classifiers to determine a likelihood that each node 106 will have content that is responsive to the query. The network interface 305 then forwards the query to the likely mobile nodes 106 and receives any responses that they may send. The network interface 305 also forwards any query responses back to the requesting user.

Referring now to FIG. 4, greater detail on a mobile node 106 is shown. The mobile node 106 includes a hardware processor 402 and a memory 404. A network interface 405 allows the mobile node 106 to communicate with the query processing system 300. As with the query processing system 300, the mobile node 106 includes one or more functional modules that may, for example, be implemented as software that is executed by hardware processor 402 and stored in memory 404 or, alternatively, may be implemented as one or more discrete hardware components.

A query execution module 408 analyzes a query that has been received at the network interface 405 from the query processing system 300. The query execution module 408 uses the terms of the query itself as well as any pertinent contextual information to determine whether any local content matches. This analysis may include an analysis of the content itself to determine its subject matter and may further consider any metadata attached to the content in the form of, e.g., tags or captions. The query execution module 408 may also consider the state of the mobile node 106 itself, for example taking into account battery capacity and existing computational load, before determining whether to respond to the query. The network interface 405 transmits any matching content back to the query processing system 300.

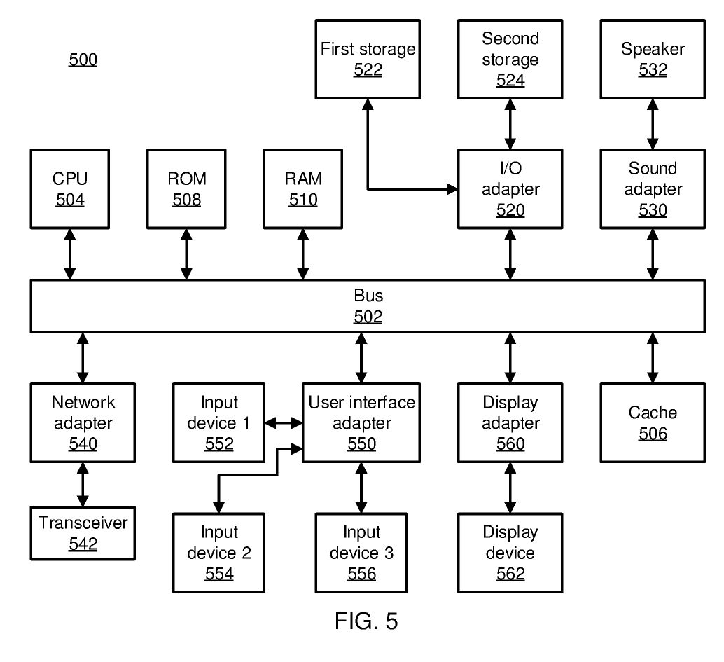

Referring now to FIG. 5, an exemplary processing system 500 is shown which may represent the transmitting device 100 or the receiving device 120. The processing system 500 includes at least one processor (CPU) 504 operatively coupled to other components via a system bus 502. A cache 506, a Read Only Memory (ROM) 508, a Random Access Memory (RAM) 510, an input/output (I/O) adapter 520, a sound adapter 530, a network adapter 540, a user interface adapter 550, and a display adapter 560, are operatively coupled to the system bus 502.

A first storage device 522 and a second storage device 524 are operatively coupled to system bus 502 by the I/O adapter 520. The storage devices 522 and 524 can be any of a disk storage device (e.g., a magnetic or optical disk storage device), a solid state magnetic device, and so forth. The storage devices 522 and 524 can be the same type of storage device or different types of storage devices.

A speaker 532 is operatively coupled to system bus 502 by the sound adapter 530. A transceiver 542 is operatively coupled to system bus 502 by network adapter 540. A display device 562 is operatively coupled to system bus 502 by display adapter 560.

A first user input device 552, a second user input device 554, and a third user input device 556 are operatively coupled to system bus 502 by user interface adapter 550. The user input devices 552, 554, and 556 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 552, 554, and 556 can be the same type of user input device or different types of user input devices. The user input devices 552, 554, and 556 are used to input and output information to and from system 500.

Of course, the processing system 500 may also include other elements (not shown), as readily contemplated by one of skill in the art, as well as omit certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 500 are readily contemplated by one of ordinary skill in the art given the teachings of the present principles provided herein.

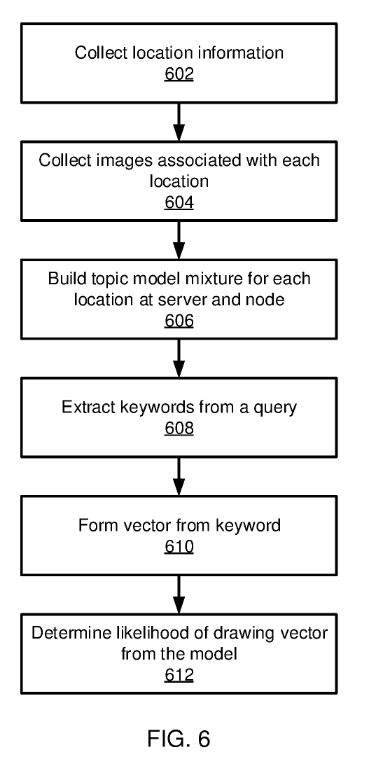

Referring now to FIG. 6, additional detail on the formation of topic models is shown. Block 602 collects location information using, e.g., the longitude and latitude of mobile nodes 106 and geo-fenced locations on maps. Locations may be considered in accordance with boundaries that are learned or specified or may instead be considered according to a node's distance from a landmark. Block 604 collects images associated with each location from, e.g., web searches. Block 606 builds a topic model mixture for each location at both the server-side processing layer 104 and at the individual mobile nodes 106 using metadata and visual features in the collected images. The mobile nodes 106 further modify the probabilistic models using local information such as, e.g., the node's location, locally stored images, metadata about the locally stored images, etc. Local optimization can also include eavesdropped information from nearby mobile nodes 106.

When a query is issued, block 608 extracts keywords from the query and block 610 generates a vector based on those keywords at the server-side processing layer 104. These vectors are then used by block 612 to determine the likelihood of drawing such vectors from the probabilistic model(s).

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A method for executing a query, comprising:
determining one or more nodes that are likely to have local content that matches a search query, using a processor, said determination being based on a location profile for each of the one or more nodes and a conditional probabilistic model for each of a set of distinct locations; and
executing the search query at the one or more nodes.

2. The method of claim 1, further comprising parsing the search query to determine at least a location component.

3. The method of claim 2, wherein determining the one or more nodes comprises matching the location component to the location profile for each of the one or more nodes.

4. The method of claim 1, further comprising receiving the search query from a query front-end.

5. The method of claim 4, further comprising forwarding a query result from the one or more nodes to the query front end.

6. The method of claim 1, further comprising constructing the conditional probabilistic model of each of a plurality of locations, wherein determining the one or more nodes based on a location profile comprises calculating a probability that each of one or more nodes possesses content that matches the search query based on the conditional probabilistic model, each node's respective location profile, and location information from the search query.

7. The method of claim 6, further comprising building a vector that includes a set of key words extracted from the search query.

8. The method of claim 7, wherein calculating the probability that each of the plurality of nodes possesses content that matches the search query comprises determining a probability of drawing the vector from the conditional probabilistic model.

9. The method of claim 6, wherein constructing the conditional probabilistic model comprises generating a server model and a local node model for each of the one or more nodes, with each local node model being further based on locally stored information.

10. A non-transitory computer readable storage medium comprising a computer readable program for executing a query, wherein the computer readable program when executed on a computer causes the computer to perform the steps of claim 1.

11. A method for executing a query, comprising:
constructing a conditional probabilistic model of each of a plurality of locations for a server and for one or more nodes, with the conditional probabilistic model for the one or more nodes being further based on locally stored information;
determining one or more nodes that are likely to have local content that matches a search query, using a processor, said determination being based on a location profile for each of the one or more nodes and comprising:
calculating a probability that each of one or more nodes possesses content that matches the search query based on the conditional probabilistic model, each node's respective location profile, and location information from the search query; and
executing the search query at the one or more nodes.

12. A system for executing a query, comprising:
a query refinement module comprising a processor configured to determine one or more nodes that are likely to have local content that matches a search query, said determination being based on a location profile for each of the one or more nodes and a conditional probabilistic model for each of a set of distinct locations, and to forward the search query to the one or more nodes for execution.

13. The system of claim 12, further comprising a query parsing module configured to parse the search query to determine at least a location component.

14. The system of claim 13, wherein the query refinement module is further configured to match the location component to the location profile for each of the one or more nodes.

15. The system of claim 12, further comprising a network interface configured to receive to receive the search query from a query front-end.

16. The system of claim 15, wherein the network interface is further configured to forward a query result from the one or more nodes to the query front end.

17. The system of claim 12, wherein the query refinement module is further configured to construct the conditional probabilistic model of each of a plurality of locations, and to calculate a probability that each of one or more nodes possesses content that matches the search query based on the conditional probabilistic model, each node's respective location profile, and location information from the search query.

18. The system of claim 17, further comprising a query parsing module configured to build a vector that includes a set of key words extracted from the search query.

19. The system of claim 18, wherein the query refinement module is further configured to determine a probability of drawing the vector from the conditional probabilistic model.

20. The system of claim 17, wherein the query refinement module is further configured to generate a server model and a local node model for each of the one or more nodes, with each local node model being further based on locally stored information.
